(19) United States
(12) Patent Application Publication
(10) Pub. No.: US 2008/0275988 A1
(43) Pub. Date: Nov. 6, 2008

(54) Method And System For Lawful Interception In Next Generation Networks

(75) Inventor: Bo Zheng, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/175,893

(22) Filed: Jul. 18, 2008

Related U.S. Application Data
(63) Continuation of application No. PCT/CN2007/000192, filed on Jan. 18, 2007.

(30) Foreign Application Priority Data
Jan. 18, 2006 (CN) 200610001517.8

(51) Int. Cl. G06F 15/173

(52) U.S. Cl. 709/224

(57) ABSTRACT

A method and system for lawful interception by Law Enforcement Agency (LEA) in next generation networks. The system includes a Delivery Function 3 (DF3) entity, an interception information provision entity, and a Border Gateway Function (BGF) entity. The method includes a Border Gateway Function (BGF) entity in a next generation network is connected with a Delivery Function 3 (DF3) entity of the LEA; an interception information provision entity sends monitored object information to the BGF entity; the BGF entity receives the monitored object information and sends the media flows corresponding to the monitored subscriber(s) according to the monitored object information to the DF3 entity.

### CROSS-REFERENCE TO RELATED APPLICATIONS

This application is a continuation of International Application No. PCT/CN2007/000192, filed Jan. 18, 2007. This application claims the benefit of Chinese Application No. 200610001517.8, filed Jan. 18, 2006. The disclosures of the above applications are incorporated herein by reference.

### FIELD

The present invention relates to an interception technology, in particular, to a method and system for lawful interception for subscribers that access Next Generation Networks (NGNs) from fixed networks.

### BACKGROUND

Lawful interception refers to a law enforcement action taken by a Law Enforcement Agency (LEA) approved by an authorization organ to monitor communication services of a public communication network in compliance with relevant national laws and industrial specifications for public communication networks. A method for lawful interception is implemented as follows: An Administration Function (ADMF) entity of the LEA sends interception data via an X1_{—}1 data interface to an interception control network element in a communication network; the interception control network element receives the interception data and then monitors a subscriber or multiple subscribers according to the interception data it receives. When detecting an activity of a monitored subscriber, the interception control network element sends Interception-Related Information (IRI) on the monitored subscriber via an X2 interface to a Delivery Function 2 (DF2) entity and also sends the media flows corresponding to the monitored subscriber via an X3 interface to a monitoring center, for example a Delivery Function 3 (DF3) entity.

A Next Generation Network (NGN) is an integrated network based on Packet Switching (PS). It provides all services of fixed networks and possesses the service capability of mobile networks. For the NGNs researched by the current standardization organizations, Core Networks (CNs) are a focus of the research. In an NGN, a CN is an IP Multimedia Subsystem (IMS) network that can provide services for both subscribers accessing the NGN from fixed networks and subscribers accessing the NGN from mobile networks.

According to the standards currently defined by the 3rd Generation Partnership Project (3GPP), in the lawful interception service for subscribers in an NGN, 3rd-Generation GPRS Support Nodes (3G GSNs) monitor the subscribers in the NGN. There are two types of 3G GSNs: GPRS Gateway Support Node (GGSN) and Serving GPRS Support Node (SGSN). Upon receipt of a media flow of a monitored subscriber, a 3G GSN sends the media flow to a DF3 entity of the LEA. The 3G GSNs in an IMS network, however, include GGSNs and SGSNs, and are involved when subscribers access the NGN from mobile networks. In other words, when a subscriber accesses the NGN from a mobile network, the media flows of the subscriber pass a 3G GSN, so that the 3G GSN duplicates the media flows of the subscriber it receives and sends a duplicate of the media flows to a monitoring center to monitor the subscriber. Nevertheless, the 3G GSNs in an IMS network are not involved when subscribers access the NGN from fixed networks. In other words, when a subscriber accesses the NGN from a fixed network, the media flows of the subscriber do not pass any 3G GSN. For this reason, the 3G GSNs cannot send the media flows of a subscriber accessing the NGN from a fixed network to a monitoring center. At present, no other means are provided to collect the media flows of a subscriber in a lawful interception scenario when the subscriber accesses the NGN from a fixed network.

Obviously, in today's NGNs, no means is available to monitor the subscribers that access NGNs from fixed networks. This greatly restricts the application scope of the lawful interception service and lowers the Quality of Service (QoS) of NGNs.

### SUMMARY

The present invention provides a method and system for lawful interception in NGNs so as to provide lawful interception for subscribers accessing NGNs from fixed networks.

To attain the above object, the present invention provides a method for lawful interception in NGNs. In an NGN, a Border Gateway Function (BGF) entity is connected with a Delivery Function 3 (DF3) entity of a Law Enforcement Agency (LEA). The method according to the present invention includes the following steps:

An interception information provision entity sends monitored object information to a BGF entity;

The BGF entity receives the monitored object information and sends media flows corresponding to a monitored subscriber(s) to a DF3 entity according to the monitored object information.

To attain the above object, the present invention further provides a system for lawful interception in NGNs, including a Delivery Function 3 (DF3) entity which is adapted to receive the media flows of monitored subscribers and analyze the received media flows so as to monitor the subscribers, an interception information provision entity, and a Border Gateway Function (BGF) entity.

The interception information provision entity is adapted to send monitored object information to a BGF entity.

The BGF entity is adapted to receive the monitored object information and sends the media flows corresponding to the subscriber(s) to a DF3 entity according to the monitored object information.

Obviously, according to the present invention, a BGF entity can trigger the duplication of media flows of monitored subscribers according to the interception data or media flow description information of the monitored subscribers when the monitored subscribers access the NGN from fixed networks, and can send a duplicate of the media flows to a DF3 entity. In this way, lawful interception is provided for subscribers accessing the NGN from fixed networks. Therefore, the application scope of the lawful interception service is greatly expanded and the QoS of the NGN is improved.

### DRAWINGS

The drawings described herein are for illustration purposes only and are not intended to limit the scope of the present disclosure in any way.

FIG. 1 shows a basic structure of the system for lawful interception in NGNs according to the present invention;

FIG. 2A1 shows a basic structure of the system for lawful interception in NGNs according to the present invention, where only an Administration Function (ADMF) entity serves as the interception information provision entity;

FIG. 2A2 shows an optimized structure of the system for lawful interception in NGNs according to the present invention, where only an ADMF entity serves as the interception information provision entity;

FIG. 2B shows a basic structure of the system for lawful interception in NGNs according to the present invention, where an ADMF entity and a Proxy Call Session Control Function (P-CSCF) entity together serve as the interception information provision entity;

FIG. 2C shows a basic structure of the system for lawful interception in NGNs according to the present invention, where an interception control network element in the NGN serves as the interception information provision entity;

FIG. 3 shows a flowchart of the method for lawful interception in NGNs according to Embodiment 1 of the present invention;

FIG. 4 shows a flowchart of the method for lawful interception in NGNs according to Embodiment 2 of the present invention;

FIG. 5 shows a flowchart of the method for lawful interception in NGNs according to Embodiment 3 of the present invention; and

FIG. 6 shows a flowchart of the method for lawful interception in NGNs according to Embodiment 4 of the present invention.

### DETAILED DESCRIPTION

Currently, the Telecommunications and Internet Converged Services and Protocols for Advanced Networking (TISPAN) organization subordinate to the European Telecommunications Standards Institute (ETSI) has defined a Resource and Admission Control Subsystem (RACS) for NGNs. The RACS includes Service Policy Decision Function (SPDF) entities, Border Gateway Function (BGF) entities, and other network elements (NEs). An SPDF entity is connected with an Administration Function (AF) entity in an IP Multimedia Subsystem (IMS) network. An AF entity is a Proxy Call Session Control Function (P-CSCF) entity. A BGF entity is connected with an SPDF entity. Moreover, a BGF entity is a packet-to-packet gateway located on a path for transmitting media flows of subscribers accessing the NGN from fixed networks. As can be seen, when a subscriber accesses the NGN from a fixed network, a BGF entity can obtain media flows of the subscriber. Therefore, BGF entities can be utilized to perform lawful interception for subscribers accessing the NGN from fixed networks. Accordingly, the present invention provides a method for lawful interception in NGNs, including the following steps:

A BGF entity is connected with a Delivery Function 3 (DF3) entity;

An interception information provision entity sends monitored object information to the BGF entity;

The BGF entity receives the monitored object information and sends media flows of the subscriber(s) according to the monitored object information to the DF3 entity.

According to the present invention, the interception information provision entity may be an ADMF entity of the LEA and then the ADMF entity may send monitored object information to a BGF entity in the following way:

A BGF entity serves as an interception control network element, that is, an ADMF entity is connected via an X1_{—}1 interface with the BGF entity, so that the ADMF entity directly sends the interception data that carries monitored subscriber identifiers as monitored object information to the BGF entity when a subscriber needs to be monitored;

Alternatively, when a subscriber needs to be monitored, an ADMF entity may send interception data to an interception control network element; the interception control network element sends a BGF entity identifier to the ADMF entity; the ADMF entity sends the interception data that carries monitored subscriber identifiers or sends the media flow description information of monitored subscribers as monitored object information to the BGF entity determined by the received BGF entity identifier.

According to the present invention, when the interception information provision entity is an ADMF entity and the interception control network element is a BGF entity, an interception data processing function entity may be preset in the NGN, so that the ADMF entity receives the interception data forwarded by the interception data processing function entity and then sends the interception data to the BGF entity.

According to the present invention, the interception information provision entity may also be an interception control network element in the NGN and then the interception control network element may send monitored object information to a BGF entity in the following way:

After receiving the interception data that carries monitored subscriber identifiers from an ADMF entity, an interception control network element in the NGN sends the interception data that carries monitored subscriber identifiers or sends the media flow description information of monitored subscribers as monitored object information to the BGF entity.

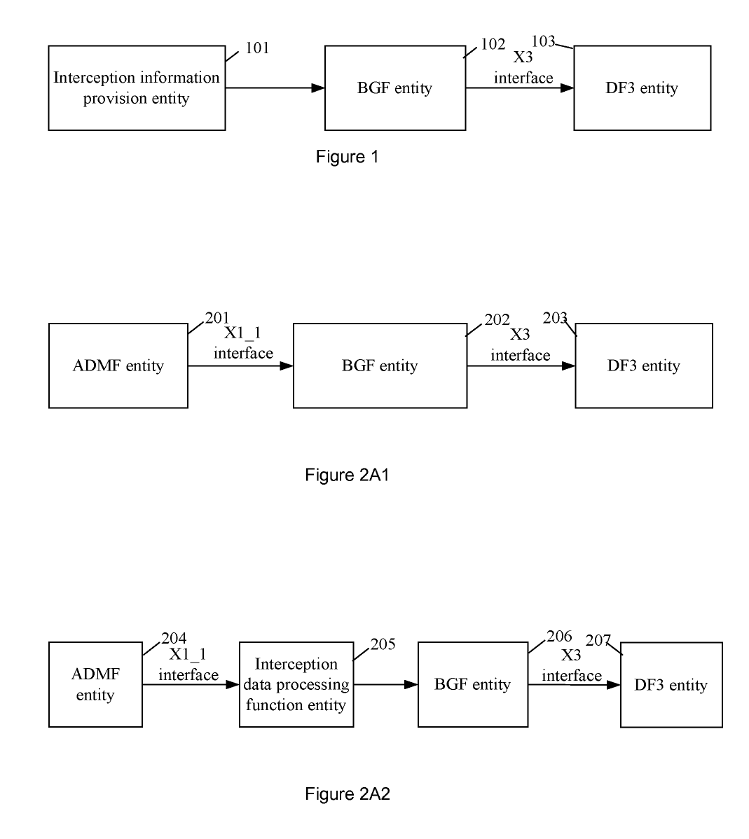

FIG. 1 shows a basic structure of the system for lawful interception in NGNs according to the present invention. As shown in FIG. 1, the present invention further provides a system for lawful interception in NGNs, including an interception information provision entity 101, adapted to send monitored object information to a BGF entity; a BGF entity 102, adapted to receive the monitored object information and send the media flows corresponding to the monitored subscriber(s) to a DF3 entity according to the monitored object information; and a DF3 entity 103, adapted to receive the media flows corresponding to the monitored subscriber(s) and analyze the received media flows for monitoring purposes.

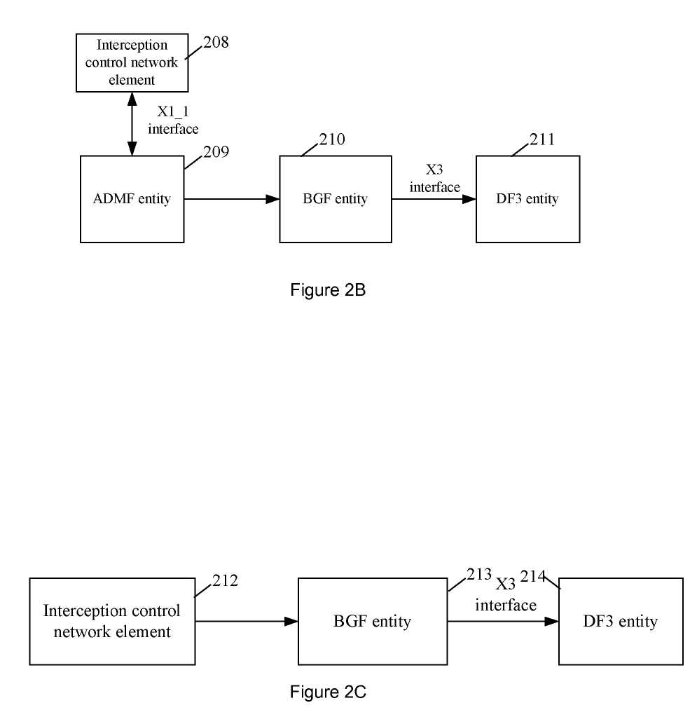

FIG. 2A1 shows a basic structure of the system for lawful interception in NGNs according to the present invention, where an Administration Function (ADMF) entity 201 serves as the interception information provision entity and a BGF entity 202 serves as the interception control network element. As shown in FIG. 2A1, in the system for lawful interception according to the present invention, the interception information provision entity may be an ADMF entity 201, which may be directly connected via an X1_{—}1 interface with a BGF entity 202 serving as the interception control network element.

FIG. 2A2 shows an optimized structure of the system for lawful interception in NGNs according to the present invention, where an Administration Function (ADMF) entity 204 serves as the interception information provision entity and a BGF entity 206 serves as the interception control network element. In a preferred embodiment of the present invention, the system may further include an interception data processing function entity 205 to avoid the case that the ADMF entity of the LEA exchanges messages with plenty of BGF entities. The ADMF entity sends interception data to the interception data processing function entity. Upon receipt of the interception data, the interception data processing function entity forwards the interception data to a BGF entity.

FIG. 2B shows a basic structure of the system for lawful interception in NGNs according to the present invention, where an Administration Function (ADMF) entity 209 serves as the interception information provision entity but the BGF entity 210 does not serve as the interception control network element. As shown in FIG. 2B, an existing interception control network element 208 may exercise the function of the interception control network element in the system according to the present invention when an Administration Function (ADMF) entity serves as the interception information provision entity but the BGF entity does not serve as the interception control network element. This interception control network element 208 may be a Lawful Interception Application Server (LI-AS), or a Proxy Call Session Control Function (P-CSCF) entity, or a Serving Call Session Control Function (S-CSCF) entity. It obtains a BGF entity identifier according to the interception data that carries monitored subscriber identifiers from the ADMF entity and sends the media flow description information of monitored subscribers to the ADMF entity according to the obtained BGF entity identifier. The ADMF entity sends the media flow description information of monitored subscribers as monitored object information to the BGF entity determined by the received BGF entity identifier.

FIG. 2C shows a basic structure of the system for lawful interception in NGNs according to the present invention, where an interception control network element 212 in the NGN serves as the interception information provision entity. As shown in FIG. 2C, in the system for lawful interception according to the present invention, an interception control network element serving as the interception information provision entity may send a message that carries the interception data sent from an ADMF entity to a BGF entity 213, or may send a message that carries the media flow description information of monitored subscribers according to the interception data that carries monitored subscriber identifiers from the ADMF entity to the BGF entity 213 in the session process.

The following drawings and embodiments are merely intended to further demonstrate and illustrate the present invention, but not to limit the scope of the present invention.

### EMBODIMENT 1

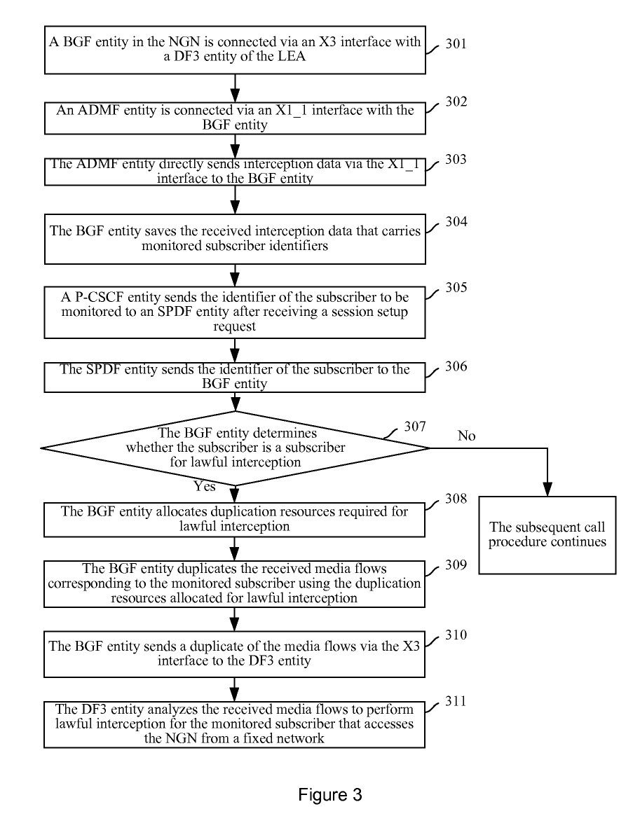

FIG. 3 shows a flowchart of the method for lawful interception in NGNs according to Embodiment 1 of the present invention. As shown in FIG. 2A1 and FIG. 3, in Embodiment 1 of the present invention, an ADMF entity of the LEA serves as the interception information provision entity and a BGF entity serves as the interception control network element. The method for lawful interception for subscribers accessing an NGN from fixed networks according to Embodiment 1 of the present invention includes the following steps.

In step 301, a BGF entity in the NGN is connected via an X3 interface with a DF3 entity of the LEA.

In step 302, an ADMF entity of the LEA is connected via an X1_{—}1 interface with the BGF entity.

In step 303, to monitor a subscriber, the ADMF entity of the LEA directly sends interception data that carries monitored subscriber identifiers via the X1_{—}1 interface to the BGF entity.

The interception data mentioned here and hereinafter may further include the other information required for subscriber monitoring, such as the identifier of the ADMF entity, the identifier of the DF3 entity to receive the media flows corresponding to the monitored subscriber(s), or the content to be monitored. Where, the monitored subscriber identifiers may be the Session Initiation Protocol Uniform Resource Identifiers (SIP URIs) or Telephone Uniform Resource Locators (TEL URLs) of monitored subscribers.

The ADMF entity sends the interception data that carries monitored subscriber identifiers to the BGF entity in steps 302 to 303. In this way, the BGF entity serving as the interception control network element obtains the interception data. In Embodiment 1 of the present invention, an entity may be involved to forward the interception data to the BGF entity serving as the interception control network element. As shown in FIG. 2A2, an interception data processing function entity is preset in the NGN and connected to both the ADMF entity of the LEA and the BGF entity according to Embodiment 1 of the present invention. The preset interception data processing function entity is connected via an X1_{—}1 interface with the ADMF entity. Therefore, the process consisting of steps 302 and 303 changes as follows:

To monitor a subscriber, the ADMF entity of the LEA directly sends interception data that carries monitored subscriber identifiers via the X1_{—}1 interface to the interception data processing function entity;

The interception data processing function entity forwards the received interception data that carries monitored subscriber identifiers to the BGF entity. The interception data processing function entity may interact with the BGF entity using a Diameter protocol.

In step 304, the BGF entity saves the received interception data that carries monitored subscriber identifiers.

In step 305, a Proxy Call Session Control Function (P-CSCF) entity sends the identifier of the subscriber to be monitored to an SPDF entity after receiving a session setup request (INVITE).

In step 305, the P-CSCF entity may send the identifier of the subscriber in an Authentication/Authorization Request (AA-Request) message to the SPDF entity. Moreover, identify of the subscriber mentioned here and hereinafter may be a SIP URI or TEL URL of the subscriber to be monitored.

In step 306, the SPDF entity sends the identifier of the subscriber to the BGF entity. Here, the SPDF entity interacts with the BGF entity using an H.248 protocol. Therefore, according to the present invention, H.248 protocol messages may be extended in advance so that a subscriber identifier package is added in an H.248 protocol message. For instance, a subscriber identifier package may be added in the following format:

PackageID: normal int (such as 0×CD)

Properties:

Subscriber Identifier:

PropertyID: SubscriberId (0×0001)

Description: It defines the Subscriber Identifier, that is, the identifier of the subscriber to be monitored.

Type: string

Defined in: Local Control descriptor

Characteristics: Read/Write

Events: none

Statistics: none

Signals: none

Procedures: A Media Gateway Controller (MGC) may specify the Subscriber Identifier in any command.

For example, SubscriberId=abcdefg@ims.example.com indicates that the Subscriber Identifier is abcdefg@ims.example.com.

Therefore, in step 306, the SPDF entity may add the identifier of the subscriber in the newly-added subscriber identifier package in an H.248 protocol message such as an Add message and then send the message to the BGF entity.

It should be noted that in steps 305 to 306, the P-CSCF entity does not directly send the identifier of the subscriber to the BGF entity. Instead, the SPDF entity sends the identifier of the subscriber in the subscriber identifier package in an extended H.248 protocol message to the BGF entity. In the practical implementation, in steps 305 to 306 mentioned above, the P-CSCF entity may send the identifier of the subscriber in the subscriber identifier package of an extended H.248 protocol message to the BGF entity: The P-CSCF entity adds the identifier of the subscriber to the extended subscriber identifier package in an H.248 protocol message and then directly sends the message to the BGF entity; alternatively, the P-CSCF entity may add the identifier of the subscriber to the newly-added subscriber identifier package in an H.248 protocol message and sends the message to the SPDF entity, which then transparently transmits the H.248 protocol message to the BGF entity.

In step 307, the BGF entity determines whether the subscriber is a subscriber for lawful interception according to the identifier of the subscriber and its own interception data that carries monitored subscriber identifiers. If the subscriber is a subscriber for lawful interception, step 308 follows. Otherwise, the subsequent call procedure continues and the current process ends.

In step 307, if the BGF entity receives an H.248 protocol message such as an Add message that carries a subscriber identifier package, then the BGF entity analyzes the received Add message and obtains the identifier of the subscriber from the subscriber identifier package in the Add message.

In step 308, the BGF entity allocates duplication resources required for lawful interception.

In step 309, a connection between the caller and the called party is set up in the session. After the caller and the called party enter a conversation, the BGF entity receives the media flows corresponding to the monitored subscriber and then duplicates these media flows using the duplication resources allocated for lawful interception.

In step 310, the BGF entity sends a duplicate of the media flows via the X3 interface to the DF3 entity.

In step 311, the DF3 entity analyzes the received media flows to perform lawful interception for the monitored subscriber that accesses the NGN from a fixed network.

### EMBODIMENT 2

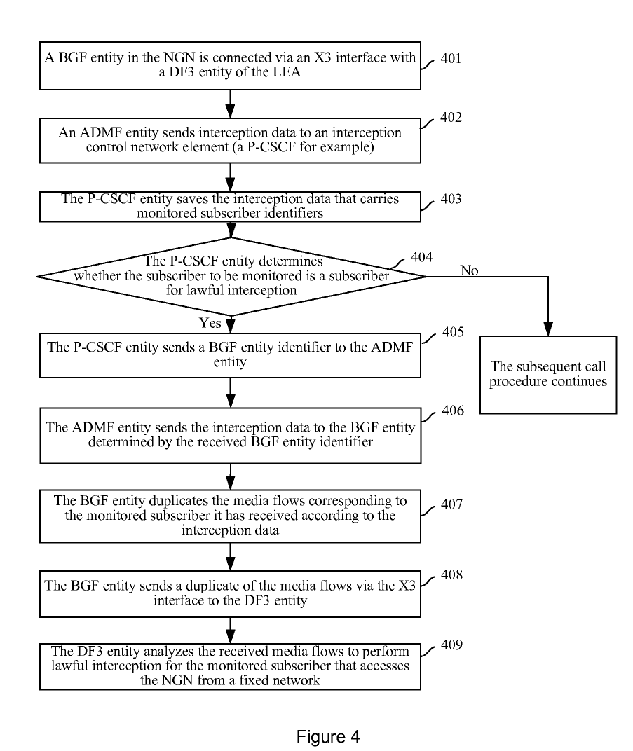

FIG. 4 shows a flowchart of the method for lawful interception in NGNs according to Embodiment 2 of the present invention. As shown in FIG. 2B and FIG. 4, in Embodiment 2 of the present invention, an ADMF entity serves as the interception information provision entity but the BGF entity does not serve as the interception control network element. The method for lawful interception for subscribers accessing an NGN from fixed networks according to Embodiment 2 of the present invention includes the following steps.

In step 401, a BGF entity in the NGN is connected via an X3 interface with a DF3 entity of the LEA.

In step 402, to monitor a subscriber, an ADMF entity of the LEA sends interception data that carries monitored subscriber identifiers via an X1_{—}1 interface to an interception control network element. Here, a P-CSCF entity, or an S-CSCF entity, or an LI-AS serving as the interception control network element can receive the interception data that carries monitored subscriber identifiers. For simplicity of the description, a P-CSCF entity is taken as the interception control network element shown in FIG. 2B to describe the subsequent implementation process of Embodiment 2 of the present invention.

In step 403, the P-CSCF entity saves the interception data that carries monitored subscriber identifiers.

In step 404, in the session setup process, the P-CSCF entity determines whether the subscriber to be monitored is a subscriber for lawful interception according to the identifier of the subscriber and its own interception data that carries monitored subscriber identifiers. If the subscriber is a subscriber for lawful interception, step 405 follows. Otherwise, the subsequent call procedure continues and the current process ends.

In step 405, the P-CSCF entity sends the identifier of the BGF entity that the media flows corresponding to the monitored subscriber in the session will pass to the ADMF entity. In this step, the P-CSCF entity may send the identifier of the BGF entity that the media flows of the monitored subscriber will pass to the ADMF entity via a DF2 entity of the LEA.

In step 406, the ADMF entity sends the interception data that carries monitored subscriber identifiers to the BGF entity determined by the received BGF entity identifier.

In step 407, the BGF entity duplicates the media flows corresponding to the monitored subscriber it has received according to the interception data that carries monitored subscriber identifiers.

In step 408, the BGF entity sends a duplicate of the media flows corresponding to the monitored subscriber to the DF3 entity according to the received interception data that carries monitored subscriber identifiers.

In the above-mentioned step 405, the P-CSCF may further send the media flow description information of the monitored subscriber in the session to the ADMF entity. Then the process consisting of steps 406 to 408 changes as follows:
The ADMF entity sends the media flow description information of the monitored subscriber to the BGF entity determined by the received BGF entity identifier;
The BGF entity duplicates the media flows corresponding to the monitored subscriber it has received according to the media flow description information of the monitored subscriber, and sends a duplicate of the media flows to the DF3 entity according to the media flow description information of the monitored subscriber it has received. The media flow description information of the monitored subscriber includes the source IP address, destination IP address, source port number and destination port number of the media flows corresponding to the monitored subscriber.

In step 409, the DF3 entity analyzes the received media flows to perform lawful interception for the monitored subscriber that accesses the NGN from a fixed network.

### EMBODIMENT 3

In Embodiment 3 of the present invention, an interception control network element in an NGN serves as the interception information provision entity. The interception control network element sends a message that carries interception data to a BGF entity to trigger the BGF entity to duplicate the media flows corresponding to the monitored subscriber(s).

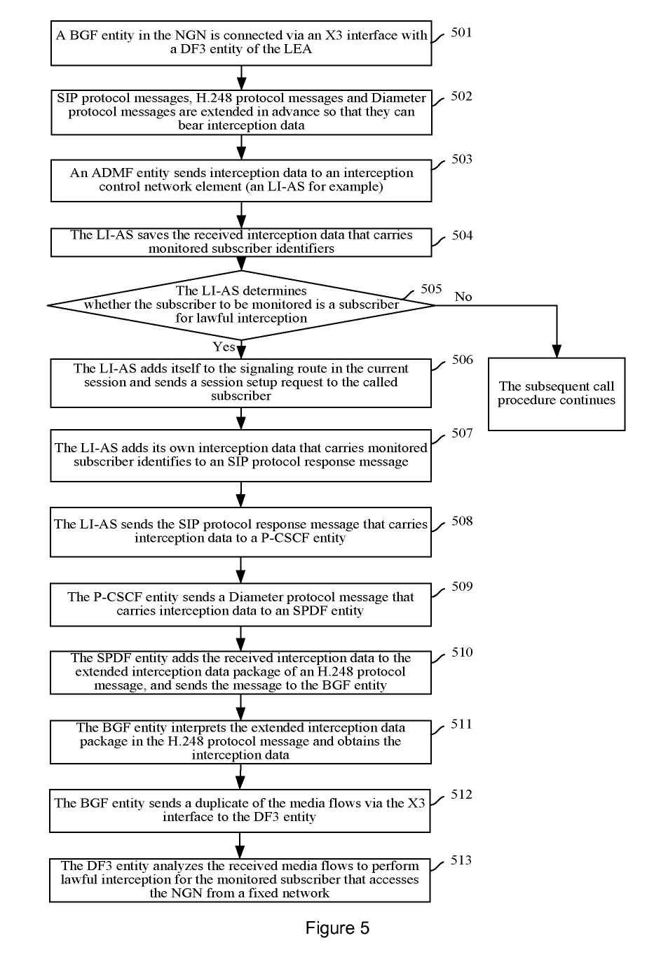

FIG. 5 shows a flowchart of the method for lawful interception in NGNs according to Embodiment 3 of the present invention. As shown in FIG. 2C and FIG. 5, to ease the description, a Lawful Interception Application Server (LI-AS) in the NGN is taken as the interception control network element. The interception control network element sends a message that carries interception data to a BGF entity to trigger the BGF entity to duplicate the media flows corresponding to the monitored subscriber(s). The method for lawful interception for subscribers accessing the NGN from fixed networks according to Embodiment 3 of the present invention includes the following steps.

In step 501, a BGF entity in the NGN is connected via an X3 interface with a DF3 entity of the LEA.

In step 502, SIP protocol messages, H.248 protocol messages and Diameter protocol messages are extended in advance so that they can bear interception data. In this step, XML-based application may be added as a new content type in a SIP protocol message to extend the SIP protocol message. For instance, the XML-based application may be added in the following format:

Content-type: application/interception-data+xml
<?xml version=“1.0”?>

<interception-data xmlns=“urn:ietf:params:xml:ns:interception-data”

version=“0” state=“full”
entity=“sip:alice@example.com”>

<monitor identity=“abcd@example.com”>

<type>both</type>
<df2addr>sip:df2@lea.com</df2addr>
<df3addr>sip:df3@lea.com</df3addr>

</monitor>

</interception-data>

In the XML-based message body mentioned above, the identifier of the current monitored subscriber is given as abcd@example.com and it is clarified that both the Interception-Related Information (IRI) and the Communication Content (CC) need to be output for the monitored subscriber. Furthermore, the address to which the IRI is to be output is specified as df2@lea.com and the address to which the monitored content is to be output is specified as df3@lea.com.

In Step 502, an interception data package may be added to H.248 protocol messages during the extension of H.248 protocol messages. For instance, an interception data package may be added in the following format:

Lawful Interception Data Package

PackageID: normal int (such as 0×CE)

Properties:

Monitored Subscriber Identifier:

PropertyID: SubscriberId (0×0001)

Description: It defines the Monitored Subscriber Identifier of a monitored object.

Type: string

Defined in: Local Control descriptor

Characteristics: Read/Write

Monitor Type:

PropertyID: MonitorType (0×0002)

Description: It defines the current Monitor Type for the monitored subscriber. If this attribute is not indicated, neither the IRI nor the Communication Content (CC) needs to be output for the monitored subscriber.

Type: Enumeration

Possible Values:

“None” (0×0000): No output

“IRI” (0×0001): Output the IRI only

“CC” (0×0002): Output the CC only

“Both” (0×0003): Output both the IRI and the CC

Default: “None” (0×0000)

Defined in: Local Control descriptor

Characteristics: Read/Write

DF2 Address:

PropertyID: DF2 Address (0×0003)

Description: It defines the DF2 address to which the IRI of the monitored subscriber is to be output.

Type: string

Defined in: Local Control descriptor

Characteristics: Read/Write

DF3 Address:

PropertyID: DF3 Address (0×0004)

Description: It defines the DF3 address to which the CC of the monitored subscriber is to be output.

Type: string

Defined in: Local Control descriptor

Characteristics: Read/Write

Events: none

Statistics: none

Signals: none

Procedures: An MGC may carry the interception data package in any command to indicate the monitored subscriber and the interception data of the subscriber.

In Step 502, an Attribute Value Pair (AVP) may be added to the previously-mentioned Diameter protocol message during the extension of a Diameter protocol message. For instance, an AVP may be added in the following format:

Attribute Name: Monitor-Data

AVP Code: An integer value such as 530. It is recommended that the AVP should carry a V bit and an M bit to indicate that the AVP is vendor-specific and must be identified by the receiver. End-to-end security encryption is allowed.

Value Type: Grouped

The AVP assumes the following format:

AVP Format:

Globally-Unique-IP-Address::=<AVP Header:xxx 13019>

[Monitored-Subscriber-Identifier]

[Monitor-Type]

[Delivery-Function2-Address]

[Delivery-Function3-Address]

Where, the Monitored-Subscriber-Identifier attribute describes the identifier of the current monitored subscriber, the Monitor-Type attribute describes whether the CC and/or the IRI of the current monitored subscriber needs to be output, the Delivery-Function2-Address attribute specifies the address to which the IRI is to be output, and the Delivery-Function3-Address attribute specifies the address to which the CC is to be output.

In step 503, to monitor a subscriber, an ADMF entity of the LEA sends interception data that carries monitored subscriber identifiers via an X1_{—}1 interface to an interception control network element. Here, a P-CSCF entity, or an S-CSCF entity, or an LI-AS serving as the interception control network element can receive the interception data that carries monitored subscriber identifiers.

In step 504, the LI-AS saves the received interception data that carries monitored subscriber identifiers.

In step 505, in the session setup process, the LI-AS determines whether the subscriber to be monitored is a subscriber for lawful interception according to the identifier of the subscriber and its own interception data that carries monitored subscriber identifiers. If the subscriber is a subscriber for lawful interception, step 506 follows. Otherwise, the subsequent call procedure continues and the current process ends.

In step 506, the LI-AS adds itself to the signaling route in the current session and sends a session setup request to the called subscriber.

In step 507, the LI-AS receives a SIP protocol response message from the called subscriber and then adds its own interception data that carries monitored subscriber identifies to the SIP protocol response message. Here, the LI-AS may add the interception data it saves to the XML-based message body of a SIP protocol response message.

In step 508, the LI-AS sends the SIP protocol response message that carries interception data to a P-CSCF entity.

It should be noted that the LI-AS involved in steps 504 to 508 may be replaced by an S-CSCF entity.

In step 509, the P-CSCF entity sends a Diameter protocol message that carries interception data to an SPDF entity. Here, the P-CSCF entity obtains interception data from the XML-based message body of the SIP protocol response message it has received, adds the interception data to the newly-added attribute value in a Diameter protocol response message, and then sends the Diameter protocol response message to the SPDF entity.

In step 510, the SPDF entity obtains interception data from the Diameter protocol response message it has received, adds the interception data to the extended interception data package of an H.248 protocol message, and sends the H.248 protocol message to the BGF entity.

In step 511, the BGF entity interprets the extended interception data package in the H.248 protocol message and obtains the interception data.

In step 512, the BGF entity duplicates the media flows corresponding to the monitored subscriber according to the interception data it has received, and sends a duplicate of the media flows via the X3 interface to the DF3 entity.

In step 513, the DF3 entity analyzes the received media flows to perform lawful interception for the monitored subscriber that accesses the NGN from a fixed network.

In Embodiment 3 of the present invention, alternatively the P-CSCF may construct a Diameter protocol message that carries interception data and then send the Diameter protocol message via the SPDF entity to the BGF entity in a similar way to that described in FIG. 5, except that the SIP message does not need to be extended.

### EMBODIMENT 4

In Embodiment 4 of the present invention, an interception control network element in an NGN serves as the interception information provision entity. The interception control network element sends a message that carries media flow topology description to a BGF entity to trigger the BGF entity to duplicate the media flows corresponding to the monitored subscriber(s).

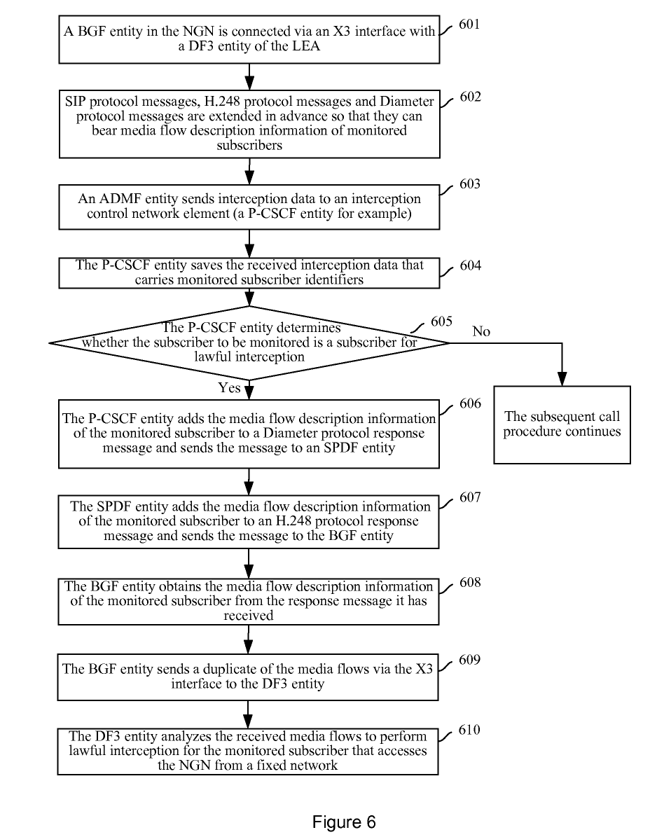

FIG. 6 shows a flowchart of the method for lawful interception in NGNs according to Embodiment 4 of the present invention. As shown in FIG. 2C and FIG. 6, to ease the description, a P-CSCF entity in an NGN is taken as the interception control network element. The interception control network element sends a message that carries media flow topology description to a BGF entity to trigger the BGF entity to duplicate the media flows corresponding to the monitored subscriber(s). The method for lawful interception for subscribers accessing the NGN from fixed networks according to Embodiment 4 of the present invention includes the following steps.

In step 601, a BGF entity in the NGN is connected via an X3 interface with a DF3 entity of the LEA.

In step 602, SIP protocol messages, H.248 protocol messages and Diameter protocol messages are extended in advance so that they can bear media flow description information of monitored subscribers.

In Step 602, a new content type (XML-based application) may be added in a SIP protocol message to extend the SIP protocol message, so that the message body carries the media flow description information of monitored subscribers. For instance, the XML-based application may be added in the following format:

Content-type: application/session-topology+xml
<?xml version=“1.0”?>

<session-topology
xmlns=“urn:ietf:params:xml:ns:session-topology”

version=“0” state=“full”
entity=“sip:alice@example.com”>

<session name=“abcd@example.com”>

<copiedstream>

<sourceaddr>[5555::1:2:3:4]:1357</sourceaddr>

<destinationaddr>[5555::a:b:c:d]:7531</destinationaddr>

<protocol>RTP</protocol>

</copiedstream>
<direction>upstream</direction>

</session>

</interception-data>

In the above-mentioned XML message body, it is clarified that the upstream media flows from [5555::1:2:3:4]:1357 to [5555::a:b:c:d]:7531 need to be duplicated for the current call.

In step 602, the standard H.248 topology description mode may be utilized to describe the topology relations between the endpoints in a Context. For the specific implementation, refer to Annex D in 3GPP 33107. Similarly, the previously-mentioned H.248 protocol message may also be extended, so that the H.248 protocol message can carry the media flow description information of monitored subscribers in an existing extended H.248 interception data package according to the following method:

Define the identifier of the interception data package.

Define the Interception indication of the interception data package, so as to indicate the master/slave attribute of the endpoints. The Interception indication attribute indicates whether the terminal at an endpoint is a slave or common terminal. If this attribute is not indicated for a terminal, the terminal is regarded as a common terminal having nothing to do with duplication.

Define the Master termination of the monitored endpoints. The Master termination attribute specifies the terminal identifier of an endpoint whose media flows are to be duplicated by a slave terminal. An endpoint whose media flows are to be duplicated is called a master endpoint and the Interception indication of a master endpoint is “common.” Master termination is effective for a slave endpoint and is a string of eight bytes.

Define the Interception mode of the monitored endpoints. The value of this attribute may be “upstream,” or “downstream,” or “both.” This attribute indicates the mode of the connection between a slave terminal and an endpoint whose media flows are to be duplicated, that is, whether to duplicate the upstream media flows, or the downstream media flows, or both the upstream and the downstream media flows of the source endpoint. This attribute is effective for a slave endpoint.

When one or multiple endpoints are indicated as slave in a Context and the master endpoint and the duplication mode of the slave endpoint(s) are specified, the slave endpoint(s) will duplicate the relevant data packages of the specified Interception mode from the specified master endpoint.

In Step 602, an Attribute Value Pair (AVP) may be added to the previously-mentioned Diameter protocol message during the extension of a Diameter protocol message, so that the Diameter protocol message can carry the media flow description information of monitored subscribers. For instance, an AVP may be added in the following format:

Attribute Name: Stream-Copied

AVP Code: An integer value such as 531. It is recommended that the AVP should carry a V bit and an M bit to indicate that the AVP is vendor-specific and must be identified by the receiver. End-to-end security encryption is allowed.

Value Type: Grouped

The AVP assumes the following format:

AVP Format:

Globally-Unique-IP-Address::=<AVP Header:xxx 13019>

[Media-Stream-Description]

[Copy-Direction]

Where, Media-Stream-Description describes the media flow information to be duplicated. For instance, Media-Stream-Description may specify the source IP address, destination IP address, source port number, destination port number, and protocol type of the media flows to be duplicated. Copy-Direction describes the duplication direction of the media flows to be duplicated. For instance, Copy-Direction may indicate that only the media flows from the source IP address to the destination IP address are to be duplicated.

In step 603, to monitor a subscriber, an ADMF entity of the LEA sends interception data that carries monitored subscriber identifiers via the X1_{—}1 interface to a P-CSCF entity serving as the interception control network element.

In step 604, the P-CSCF entity saves the received interception data that carries monitored subscriber identifiers.

In step 605, in the session setup process, the P-CSCF entity determines whether the subscriber to be monitored is a subscriber for lawful interception according to the identifier of the subscriber and its own interception data that carries monitored subscriber identifiers. If the subscriber is a subscriber for lawful interception, step 606 follows. Otherwise, the subsequent call procedure continues and the current process ends.

In step 606, the P-CSCF entity adds the media flow description information of the monitored subscriber in this session to a Diameter protocol response message and sends the Diameter protocol response message to an SPDF entity. Here, according to the process given in Step 602 for extending a Diameter protocol message, the P-CSCF entity may use the attribute value newly added in a Diameter protocol response message to carry the media flow description information of the monitored subscriber.

In step 607, the SPDF entity adds the media flow description information of the monitored subscriber in this session to an H.248 protocol response message and sends the H.248 protocol response message to the BGF entity. Here, according to the process given in Step 602 for extending an H.248 protocol message, the SPDF entity may use the interception data package newly added in an H.248 protocol response message to carry the media flow description information of the monitored subscriber.

In step 608, the BGF entity obtains the media flow description information of the monitored subscriber in this session from the response message it has received.

In step 609, the BGF entity duplicates the media flows corresponding to the monitored subscriber according to the media flow description information of the monitored subscriber it has received, and sends a duplicate of the media flows via the X3 interface to the DF3 entity.

In step 610, the DF3 entity analyzes the received media flows to perform lawful interception for the monitored subscriber that accesses the NGN from a fixed network.

In Embodiment 4 of the present invention, the P-CSCF entity first constructs a message that carries the media flow description information of monitored subscribers and then sends the message via the SPDF entity to the BGF entity. In the practical implementation, the LI-AS or the S-CSCF entity may first construct an extended SIP protocol message that carries the media flow description information of monitored subscribers and then send the message via the P-CSCF entity and the SPDF entity to the BGF entity in a way similar to that described in FIG. 6.

In the present invention, the query command, lawful interception deactivation command or other commands sent by the ADMF entity may be sent in the methods according to the embodiments of the present invention to the BGF entity, so as to trigger the BGF entity to query the relevant attributes of the monitored subscriber(s), or cancel lawful interception, or perform other related operations.

According to the present invention, the subscriber(s) to be monitored may be the calling subscriber and/or the called subscriber in the session.

According to the present invention, the BGF entity may be an Access Border Gateway Function (A-BGF) entity that provides connections between subscriber terminals and the access network, or a Core Border Gateway Function (C-BGF) entity that provides connections between the access network and the core network.

While this invention has been particularly shown and described with reference to preferred embodiments thereof, it will be understood by those skilled in the art that various changes in form and details may be made therein without departing from the spirit and scope of the invention as defined by the appended claims.

What is claimed is

1. A method for lawful interception in next generation networks, wherein a Border Gateway Function entity of the next generation networks is connected to a Delivery Function 3 entity of a Law Enforcement Agency, and the method comprising:
A, receiving, by the Border Gateway Function entity monitored object information sent from an interception information provision entity; and
B, sending, by the Border Gateway Function entity, media flows corresponding to a monitored subscriber to the Delivery Function 3 entity according to the received monitored object information.

2. The method according to claim 1, further comprising:
arranging an interception data processing function entity in the next generation networks, and making the arranged interception data processing function entity communicate respectively with an Administration Function entity and the Border Gateway Function entity;
wherein the monitored object information is interception data carrying monitored subscriber identifiers; and A further comprises:
sending, by the Administration Function entity, the interception data carrying monitored subscriber identifiers to the interception data processing function entity;
receiving, by the Border Gateway Function entity the interception data carrying monitored subscriber identifiers sent from the interception data processing function entity.

3. The method according to claim 1, wherein the interception information provision entity is an Administration Function entity of the Law Enforcement Agency, A further comprises:
A21, sending, by the Administration Function entity of the Law Enforcement Agency, the interception data carrying monitored subscriber identifiers to an existing interception control network element, and the interception control network element storing the received interception data carrying monitored subscriber identifiers;
A22, determining, by the interception control network element, whether a subscriber is a monitored subscriber according to the stored interception data carrying monitored subscriber identifiers and an identifier of the subscriber in a session setup process, if the subscriber is a monitored subscriber, performing A23;
A23, sending, by the interception control network element, an identifier of the Border Gateway Function entity to the Administration Function entity of the Law Enforcement Agency, wherein media flows corresponding to the monitored subscriber passes through the Border Gateway Function entity;
A24, receiving, by the Border Gateway Function entity the monitored object information sent from the Administration Function entity of the Law Enforcement Agency, wherein the Administration Function entity of the Law Enforcement Agency sends the monitored object information to the Border Gateway Function entity according to the received identifier of the Border Gateway Function entity.

4. The method according to claim 3, further comprising:
extending an H.248 protocol message and diameter protocol message;
wherein the interception control network element is a Proxy Call Session Control Function entity;
before A, the method further comprising:
sending, by an Administration Function entity of a Law Enforcement Agency, interception data carrying monitored subscriber identifiers to the Proxy Call Session Control Function entity;
and A further comprising:
A31, determining, by the Proxy Call Session Control Function entity, whether a subscriber is a monitored subscriber according to the received interception data carrying monitored subscriber identifiers and an identifier of the subscriber in a session setup process, if yes, turning to A32;
A32, sending, by the Proxy Call Session Control Function entity, the monitored object information to a service policy decision function entity via the extended diameter protocol message;
A33, receiving, by the Border Gateway Function entity the monitored object information sent from the service policy decision function entity via the extended H.248 protocol message.

5. The method according to claim 3, further comprising:
extending an H.248 protocol message, diameter protocol message and session initiation protocol message;
wherein before A, the method further comprises:
receiving interception data carrying monitored subscriber identifiers from an Administration Function entity of a Law Enforcement Agency;
and A further comprising:
A41, determining whether a subscriber is a monitored subscriber according to the received interception data carrying monitored subscriber identifiers and an identifier of the subscriber in a session setup process, if yes, turning to A42;
A42, sending the monitored object information to a Proxy Call Session Control Function entity via the extended session initiation protocol message;
A43, sending, by the Proxy Call Session Control Function entity, the monitored object information to a service policy decision function entity via the extended diameter protocol message;
A43, receiving, by the Border Gateway Function entity the monitored object information sent from the service policy decision function entity via the extended H.248 protocol message.

6. The method according to claim 5, wherein a lawful interception application server or a Server Call Session Control Function entity performs the procedure of receiving interception data, determining and sending the monitored object information to the Proxy Call Session Control Function entity via the extended session initiation protocol message.

7. The method according to claim 4, wherein:
the procedure for extending the H.248 protocol message further comprises:
adding an interception data package in the H.248 protocol message; and
the procedure for sending the monitored object information to the Border Gateway Function entity via the extended H.248 protocol message further comprises:
carrying, by the service policy decision function entity, the monitored object information in the added interception data package of the H.248 protocol message, and sending the H.248 protocol message to the Border Gateway Function entity.

8. The method according to claim 4, wherein
the procedure for extending the diameter protocol message further comprises:
adding an attribute value pair in the diameter protocol message; and
the procedure of sending the monitored object information to the service policy decision function entity via the diameter protocol message further comprises:
carrying the monitored object information in the added attribute value pair of the diameter protocol message, and sending the diameter protocol message to the service policy decision function entity.

9. The method according to claim 5, wherein the procedure for extending the session initiation protocol message further comprises:
adding an application type based XML format in the session initiation protocol message;
and wherein the A42 further comprises:
carrying the monitored object information in a message body of the application type based XML format, and sending the session initiation protocol message to Proxy Call Session Control Function entity.

10. A system for lawful interception in next generation networks, comprising:
a Delivery Function 3 entity adapted to receive media flows corresponding to monitored subscribers and analyze the received media flows so as to monitor subscribers;
wherein the system further comprises: an interception information provision entity, and a Border Gateway Function entity; wherein
the interception information provision entity is adapted to send monitored object information to the Border Gateway Function entity; and
the Border Gateway Function entity is adapted to send media flows corresponding to the monitored subscribers to the Delivery Function 3 entity according to the received monitored object information.

11. The system according to claim 10, wherein the interception information provision entity is an Administration Function entity of a Law Enforcement Agency.

12. The system according to claim 11, wherein the Administration Function entity of a Law Enforcement Agency is connected to the Border Gateway Function entity via X1_{—}1 interface.

13. The system according to claim 11, further comprising:
an interception data processing function entity, adapted to receive interception data carrying monitored subscriber identifiers from the Administration Function entity of the Law Enforcement Agency via X1_{—}1 interface, and send the interception data carrying monitored subscriber identifiers to the Border Gateway Function entity;
wherein the Administration Function entity of the Law Enforcement Agency is adapted to send the interception data carrying monitored subscriber identifiers to the interception data processing function entity.

14. The system according to claim 11, further comprising:
an existing interception control network element, adapted to receive the interception data carrying monitored subscriber identifiers sent from the Administration Function of the Law Enforcement Agency, obtain an identifier of the Border Gateway Function entity passed through by the media flows corresponding to monitored subscribers, and send the obtained the identifier of the Border Gateway Function entity to the Administration Function entity of the Law Enforcement Agency;
wherein the Administration Function entity of the Law Enforcement Agency is adapted to send the interception object information to the Border Gateway Function entity.

15. The system according to claim 10, wherein the interception information provision entity is existing interception control network element adapted to obtain description information of the media flows corresponding to the monitored subscriber according to interception data carrying monitored subscriber identifiers sent from an Administration Function of an Law Enforcement Agency, and send the description information of the media flows corresponding to the monitored subscriber to the Border Gateway Function entity, or send directly the interception data carrying monitored subscriber identifiers to the Border Gateway Function entity;
wherein the Border Gateway Function entity is adapted to send the received description information of the media flows corresponding to the monitored subscriber or the interception data carrying monitored subscriber identifiers to the Delivery Function 3 entity.

16. A Border Gateway Function entity, comprising:
a first unit, adapted to receive monitored object information sent from an interception information provision entity; and
a second unit, adapted to send media flows corresponding to the monitored subscribers to the Delivery Function 3 entity according to the received monitored object information.
